(19) United States
(12) Patent Application Publication
(10) Pub. No.: US 2012/0088052 A1
(43) Pub. Date: Apr. 12, 2012

(54) Water-Base Acrylic Premanufactured Waterproofing Material and Process for Obtaining the Same

(75) Inventor: Ricardo Rodriguez Cantu, Monterrey Nuevo Leon (MX)

(73) Assignee: PREFACRIL S.A. DE C.V., Monterrey Nuevo Leon (MX)

(21) Appl. No.: 13/270,997

(22) Filed: Oct. 11, 2011

Related U.S. Application Data
(63) Continuation of application No. PCT/MX2011/000090, filed on Jul. 21, 2011.

(30) Foreign Application Priority Data
Oct. 12, 2010 (MX) MX/A/2010/011190

(51) Int. Cl. B32B 27/30; B32B 27/12; B32B 15/08; B32B 37/14; B05D 5/00; B32B 37/02; B32B 37/12; B05D 3/02; B32B 27/10; B32B 17/10

(52) U.S. Cl. 428/41.3; 428/522; 428/213; 428/514; 428/463; 428/442; 442/79; 428/454; 427/385.5; 156/182; 156/60

(57) ABSTRACT

The invention regards a water-base acrylic premanufactured waterproofing material and the procedure for obtaining the same. The material includes a substrate, base or support to give it a continuous structure adapted to receive on its top side a first layer of a water-base acrylic waterproofing composition forming a waterproof film and at least one second layer forming a waterproof film on this first layer, of a water-base acrylic waterproofing composition, equal to or different from the composition of the first layer, having, in addition, opposite the side where the at least two layers of an acrylic waterproofing composition are applied, a layer or film of an adhesive.

### FIELD OF THE INVENTION

The present invention falls generally in the field of the construction industry and the chemical industry; in particular, it is related to the industry producing waterproof coverings and more especially to the industry involved in the formulation, development and production of waterproofing materials for roofs and different construction substrates in civil works. More especially, the invention regards a water-base acrylic premanufactured waterproofing material and the procedure for obtaining the same.

### BACKGROUND

As is well-known, waterproof coverings for various constructions have the objective of preventing the passage of water, for the insulation of humidity and water of different origins, through the spaces and pores formed by the construction materials that make up walls, slabs, marquees and other structures covering closed or open spaces.

In the state of the art, some systems of waterproof coverings are known, such as asphalt, acrylic or cement systems and the premanufactured system.

Asphalt covering systems can be multilayer, water-base and solvent-base, ideal for applying mainly on roofs and humid or dry flat roofs in warm or temperate climates; water-base waterproofing systems are ideal for applying mainly on roofs and humid or dry flat roofs in warm or temperate climates; whereas solvent-base waterproof systems are ideal for all types of dry structures, floors under stone covers (mosaic, tiles, etc.), sites under constant immersion like ponds or flower boxes, and are also for all types of climates. They have greater durability than the asphalt or water-base ones.

The acrylic covering system comprises waterproofing materials made of water-base liquid acrylic compositions that, once applied, form an waterproof film on the surface where it is applied, which are of easy application, high reflectivity, and, due to its elasticity, does not crack or split; it is 100% waterproof, ideals for roofs, and horizontal and inclined flat roofs, is applied on concrete, mortar, asbestos or galvanized sheet surfaces.

The cement covering system comprises waterproofing products that are used on concrete, cement, and surfaces, reducing the penetration of water in the structure; its application varies, depending on the type of waterproofing to be use.

The premanufactured waterproof coverings system comprises rolls of waterproofing material that extend on a surface adhering them with a heat source that allows a partial melting of the polymeric material for its adhesion; they are products made with at least one asphalt layer modified with synthetic polymers and a load of calcium carbonate (CaCO3), at least one reinforcement membrane integrated from manufacturing process, some finishing layer like gravel; which guarantees a uniform thickness of the roll. Premanufactured waterproofing materials are produced with asphalt base modified with elastomers, forming elastic or plastomer mixtures.

As is know, asphalt is a residue from petroleum distillation. It is a viscous, sticky material of black color, used as a binder in asphalt mixtures, composed almost in its totality by bitumen, which is a black mixture of highly viscous and sticky organic liquids. It is one hundred percent waterproof, ductile, adherent, is a semiliquid soft product at room temperature.

Premanufactured systems serve to waterproof areas with greater speed, uniform thickness and high durability.

The premanufactured waterproof coverings system that comprises rolls of waterproofing material as previously described is very common and much used at present, although very expensive and with many disadvantages of handling, installation, transport and manufacture.

Asphalt compositions for premanufactured waterproofing membranes are generally composed of an asphalt plus a primary modifying agent which comprises a commonly used polymer generally selected from styrene-butadiene (SBS) or atactic polypropylene (APP), plus a secondary modifying agent which normally comprises a load of calcium carbonate (CaCO3).

Asphalt modified with these polymers offers premanufactured waterproofing membranes a certain elongation, a certain flexibility, a certain hardness, mechanical strength, high impermeability; although it is not reflective, it requires specialized tools for its installation and qualified manpower.

Nevertheless, in certain compositions of the state of the art, the covering often has defects such as blisters and bubbles in the surface that can cause loosening of the membrane, reducing the protection of the substrate; in other cases they tend to lose elasticity with the passage of time or in conditions of low or very high temperatures, they being able at high temperatures to modify their structure before the action of a weight leaving marks, reducing mechanical strength and also affecting the structural shape, so that considerably less functional points are created in those zones, which reduces its waterproofing capacity; at low temperatures, cracks and splits arise that damage the structure of the waterproofing membrane and are centers for the entrance of humidity and water. These splits can also arise in waterproofing membranes due to the rigidity that is created by heating and cooling processes, both of the waterproofing membrane as well as of the substrate.

A disadvantage of some compositions used to waterproof civil work constructions with this type of waterproofing is that of being too viscous; a high viscosity makes the application difficult, leaving zones of less mechanical strength that absorb expansions and contractions of film and substrate.

Related to the aforementioned, we also have the problem of freezing that appears in some films, resulting from application of certain modified asphalt compositions.

Therefore, it is also required to determine suitable percentage of polymers, asphalt and the CaCO3 load.

These asphalt premanufactured waterproofing materials also represent a problem as far as their handling. It is a very heavy product, its application is slow, that is to say, it requires greater installation time, specialized equipment, and qualified personnel for it.

Asphalt premanufactured waterproofing materials require a very expensive manufacturing process that involves multiple steps, multiples control factors and variables; complex equipment and machinery, as well as multiple consumptions.

With regard to current acrylic waterproofing materials, some take as the application system a reinforcement fabric prior to application of the acrylic waterproofing material, which increases the manpower of the application and materials, greater application time and require specialized manpower. The constant climatic changes that generate drastic fluctuations in temperature, relative humidity, frequent rains during the rainy season, etc., cause the reinforcement fibers to crack and damage in a short time. Acrylic waterproofing materials can likewise be diluted by the person who applies them, reducing their physicochemical properties and affecting the quality of the membrane that is generated upon drying, lowering the properties and its durability, and application times are greater. In some cases, it is recommended to carry out two applications or passes to obtain better results.

It is important also to emphasize that water-base acrylic waterproofing materials generally carry a high percentage of water that will evaporate once applied, which implies that almost 50% or more of the acquired product is water.

In addition, in conditions in which the waterproofing material is dry, the elasticity is not preserved and generates breaking of the reinforcement fabric, which causes grooves or seams in the waterproofing surface, and therefore filtrations that affect the earlier waterproofed surface.

To date, all premanufactured waterproofing materials are made based on an asphalt composition with the disadvantages already described. On the other hand, all known acrylic waterproofing materials comprise water-based elastomeric acrylic waterproofing compositions which can be fibrated or nonfibrated (with incorporation or not of reinforcement fibers—acrylic, polyester, polypropylene, nylon, cellulose, glass fibers) and which are liquid waterproofing materials that only up to their application form a waterproof film.

No premanufactured waterproofing product is known on the market, nor in the state of the art, that uses an association of a substrate or support with at least two layers of a water-base acrylic waterproofing composition. For this reason and seeing the economic and commercial advantages that it implies, serious and deep investigation was carried out to develop a product that allows that association, that offers better structural and functional qualities, that in addition is more lasting, elastic, of easy application and that offers better results and greater efficiency, which produced as a result the invention of the product that is the reason for this description.

The present invention has as its general objective to make available a water-base acrylic premanufactured waterproofing material, more efficient structurally and functionally which, moreover, is lighter.

Another objective of the invention is to make available this water-base premanufactured waterproofing material which, moreover, is a light product, of fast and easy application and that does not require any specialized tool or specialized manpower for its installation.

Another objective of the invention is to allow this water-base premanufactured waterproofing material which, moreover, is structurally resistant, lasting, with high waterproof and ecological capacity.

A further objective of the invention is to make available this water-base premanufactured waterproofing material which, moreover, is a constant thickness before, during and after its application.

A further objective of the invention is to make available this water-base premanufactured waterproofing material which, moreover, has on the whole controlled elongation properties without these being lost once applied.

A further objective of the invention is to make available this water-base premanufactured waterproofing material whose application, moreover, is very clean, fast and controlled.

A further objective of the invention is to make available this water-base premanufactured waterproofing material which, moreover, allows reducing manufacturing costs and final product sale prices compared to asphalt premanufactured waterproofing materials.

Still another objective of the invention is to make available this water-base premanufactured waterproofing material which, moreover, considerably reduces application costs and times.

Still another objective of the invention is to make available this water-base acrylic premanufactured waterproofing material which, moreover, generates a smaller volume in its display for sale, reducing weight and facilitating its handling, considerably reducing, moreover, transport costs.

Still another objective of the invention is to make available a novel procedure for obtaining a water-base acrylic premanufactured waterproofing material.

And all those qualities and objectives that will become apparent from a general and detailed description of the present invention supported in the illustrated embodiments.

### SUMMARY OF THE INVENTION

In a general way, the water-base acrylic premanufactured waterproofing material in accordance with the present invention, comprises a substrate, base or support to give it a continuous structure adapted to receive on its top side a first layer of a water-base acrylic waterproofing composition forming a waterproof film and at least one second layer forming a waterproof film on this first layer, of a water-base acrylic waterproofing composition, equal to or different from the composition of the first layer.

This first layer and this at least one second layer of a water-base acrylic waterproofing composition of this premanufactured waterproofing material have equal or different thickness. This acrylic waterproofing composition can be styrenated or not.

This substrate, base or support to give a continuous structure to the premanufactured waterproofing material is selected from a plastic film, rubber, a sheet of paper, cardboard, aluminum paper, fiber glass and preferably a fabric or nonfabric textile.

When the substrate, base or support comprises a fabric or nonfabric textile, this can be made of synthetic or natural fibers, of a material selected among polyethylene, polypropylene, polyester, nylon, elastomerie polyurethane, glass fibers, natural or cellulose fibers with a predetermined length, caliber and strength.

This textile material in its preferred embodiment is made of filaments with a predetermined caliber and a horizontal, vertical or mixed framework that can have a density over a wide range with capacity of vertical and longitudinal elongation.

This water-base acrylic waterproofing composition forming a film for the first and the at least second layer on the substrate, base or support, comprises water, a water softener, a moisturizer, an antifreeze, an antifoaming agent, pigments, fine, medium and/or thick loads, a binder or film former (resin), a germicide, a pH regulator, a coalescent, may or may not contain fiber, a thickener and a dispersant.

The water softener and stabilizer comprises sodium or potassium tripolyphosphate, sodium or potassium hexaphosphate; the moisturizer comprises nonylphenol ethoxylate or another organic; the antifreeze comprises monoethylene glycol, diethylene glycol and/or propylene glycol; the antifoaming agent is a mineral oil base antifoaming agent; the pigments are selected among titanium dioxide, iron oxide (red, yellow, green and black), phthalos or phthaloeyanine or other pigments; the loads are selected from calcium carbonate, natural or artificial kaolin, talc, alumina, silicates, feldspar, mica, baryta and wollastonite, employing preferably a fine and medium calcium carbonate mixture; the pH regulator is ammonia and/or amine derivatives; the germicide is formaldehyde or another organic biocide; the coalescent is pentanediol; the thickener is of acrylic, cellulose or polyurethane, and the dispersant is sodium or ammonium polyacrylate.

In the embodiment in which this water-base acrylic waterproofing composition comprises mechanical reinforcement fibers, these are selected among polyester fibers, polyethylene fibers, elastane fibers, rubber fiber (alloy type), neoprene fiber, natural oilcloth fiber or synthetic oilcloth, preferably with a caliber of 0.05-20 mm, as well as other natural elastic fibers and synthetic elastic fibers. By “elastic fibers” are meant those that stretch without breaking and when loosen recover their initial state, although they show fatigue and do not reach their original length.

The major solid content determines the useful life of the waterproofing material, so that the useful life is directly proportional to the content of solids and inversely proportional to the water content. The solids in the waterproofing material are defined by the quantity of resin and pigments. In accordance with this rule, the waterproofing material can be designed for different lifetimes.

The water-base acrylic waterproofing composition that forms the first layer and the at least second layer on the substrate, base or support comprises the following physicochemical properties that are shown in the following chart:

| PHYSICOCHEMICAL PROPERTY | QUANTITY |
|---|---|
| Solids | 40-70% |
| Density | 1.10-1.45 |
| PH | 7.6-10.5 |
| Viscosity | 10,000-80,000 Cps |

The water-base acrylic premanufactured waterproofing material is applied on a surface to waterproof, employing an adhesive that is applied on the surface to be waterproofed and/or on the bottom side of this premanufactured waterproofing material defined by the substrate, base or support. This adhesive comprises a water-base or resin-base adhesive of the styrene acrylic resins or 100% acrylic resins or polyurethane resins type, or it can include a pasty adhesive.

In another embodiment of the invention, this premanufactured waterproofing material comprises on the bottom side of its substrate, base or support, opposite the side where the at least two layers of an acrylic waterproofing composition are applied, a layer or film of a water-base or resin-base adhesive of the styrene acrylic resins or 100% acrylic resins or polyurethane resins type.

In another embodiment of the invention, this adhesive is directly applied on the bottom side of the substrate, support or base by impregnation, aspersion, or laminated employing a film of double-sided adhesive material with a backing material that, when detached, leaves exposed the adhesive film to fix the premanufactured waterproofing material to the surface to be waterproofed.

In another embodiment of the invention, this substrate, base or support of the premanufactured waterproofing material comprises on the bottom side at least one layer of a water-base acrylic resin or at least one layer of a composition of a water-base acrylic waterproofing material equal to or different from the acrylic waterproofing composition of the at least two layers of the top side of the substrate, support or base or a sealant type waterproofing material, which may or may not comprise in addition at least one layer or film of an adhesive as has already been described to favor adhesion.

In order to better understand the characteristics of the invention, this description is accompanied, as an integral part of the same, by drawings of a nonlimiting illustrative character, which are described below.

### BRIEF DESCRIPTION OF THE DRAWINGS

FIG. 1 shows a cross section of the water-base acrylic premanufactured waterproofing material in accordance with the present invention.

FIG. 2 illustrates a cross section of the water-base acrylic premanufactured waterproofing material in another embodiment of the present invention.

FIG. 3 illustrates a cross section of the water-base acrylic premanufactured waterproofing material in another embodiment of the present invention.

FIG. 4 shows a schematic diagram of a section of the waterproofing material in accordance with the present invention.

FIG. 5 shows a block diagram of the process for obtaining the water-base acrylic premanufactured waterproofing material in accordance with the present invention.

For a better understanding of the invention, we go on to give a detailed description of some of the embodiments of the same, shown in the drawings with nonlimiting illustrative aims that are attached to this description.

### DETAILED DESCRIPTION OF THE INVENTION

The characteristic details of the water-base acrylic premanufactured waterproofing material are clearly shown in the following description and in the illustrative drawings that are attached, the same serving as references to indicate the same parts to which reference is made.

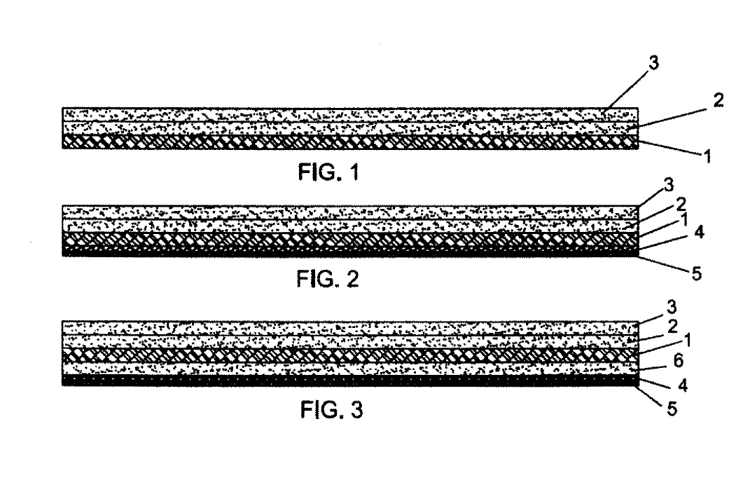

Reference is made to FIG. 1, which shows a cross section of the water-base acrylic premanufactured waterproofing material in accordance with the present invention. In this figure, the water-base acrylic premanufactured waterproofing material in accordance with the present invention comprises a substrate, base or support 1 that supplies body and a continuous structure which receives on its top side a first layer 2 of a water-base acrylic waterproofing composition forming a waterproof film and at least a second layer 3 forming a waterproof film on this first layer, of a water-base acrylic waterproofing composition equal to or different from the composition of the first layer. The number of layers can be greater than two, and the water-base acrylic waterproofing compositions can be equal or different, likewise the thickness of these.

Reference is made to FIG. 2, which illustrates a cross section of the water-base acrylic premanufactured waterproofing material in another embodiment of the present invention. In this figure, it can be noticed that the water-base acrylic premanufactured waterproofing material, with the substrate, base or support 1 that supplies body and a continuous structure, receives on its top side a first layer 2 of a water-base acrylic waterproofing composition forming a waterproof film and at least a second layer 3 forming a waterproof film on this first layer, of a water-base acrylic waterproofing composition equal to or different from the composition of the first layer. The bottom side of this substrate, base or support 1 comprises a adhesive layer or film 4 with a film backing 5, which rolls on the bottom side of this substrate 1 and, when detached, leaves exposed the adhesive film to fix the premanufactured waterproofing material to the surface to be waterproofed.

Reference is made to FIG. 3, which illustrates a cross section of the water-base acrylic premanufactured waterproofing material in another embodiment of the present invention. In this figure, it can be noticed that the water-base acrylic premanufactured waterproofing material, with the substrate, base or support 1 that supplies body and a continuous structure, receives on its top side a first layer 2 of a water-base acrylic waterproofing composition forming a waterproof film and at least a second layer 3 forming a waterproof film on this first layer, of a water-base acrylic waterproofing composition equal to or different from the composition of the first layer. The bottom side of this substrate, base or support 1 comprises at least one layer 6 of a water-base acrylic resin or of a sealant type waterproofing material or of a water-base acrylic waterproofing composition equal to or different from the acrylic waterproofing composition of the at least two layers of the top side of the substrate, support or base 1 which saturates this substrate, base or support 1 and which receives an adhesive layer or film 4 with a film backing 5, which rolls and, when detached, leaves exposed the adhesive film to fix the premanufactured waterproofing material to the surface to be waterproofed.

The waterproofing material thus structured offers great advantages from a structural and functional point of view, and the same can easily be transported upon being rolled up, since its structure is light and of easy handling, which greatly facilitates its installation in much shorter times, without requiring specialized manpower or special equipment to do it.

The waterproofing material has greater reflectivity of solar rays, is self-washing and allows a constant thickness before, during and after its application. Besides this, the waterproofing material has a fine elongation as a system.

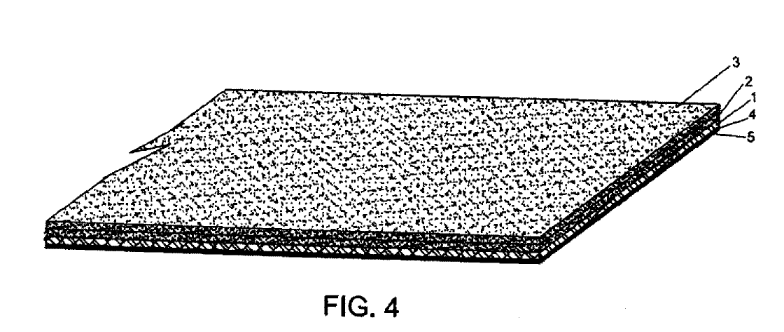

Reference is made to FIG. 4, which shows a schematic diagram of a section of the waterproofing material in accordance with the present invention. In this figure, a section of the waterproofing material in one of its preferred embodiments is seen, showing the first layer 2 of a water-base acrylic waterproofing composition forming a waterproof film on the substrate, base or support 1 and the at least one second layer 3 forming a waterproof film on this first layer 2, of a water-base acrylic waterproofing composition equal to or different from the composition of the first layer.

Layer or film 4 of a water-base or resin-base adhesive of the styrene acrylic resins or 100% acrylic resins or polyurethane resins type applied on the bottom side of the substrate, base or support 1 in the embodiment shown in FIG. 2 with the film backing 5.

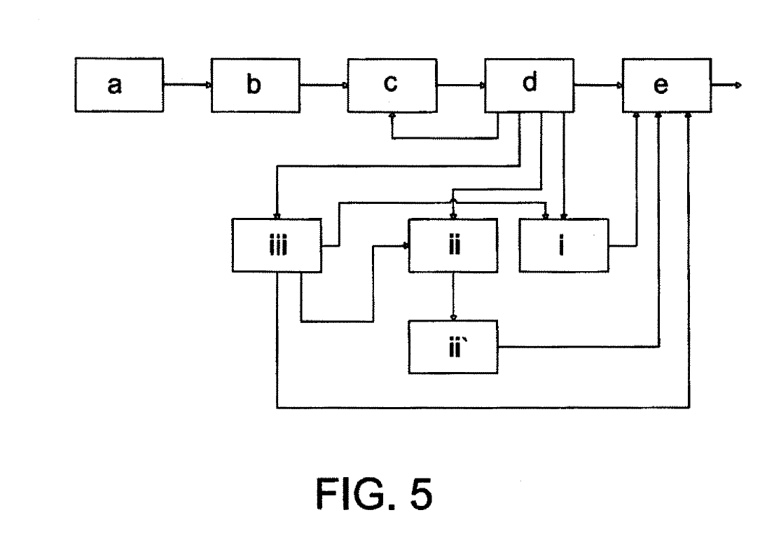

Reference is made to FIG. 5, which shows a block diagram of the process for obtaining the water-base acrylic premanufactured waterproofing material in accordance with the present invention. In this figure are seen the steps of the process, which comprises the following steps: a) apply a first layer of predetermined thickness of a water-base acrylic waterproofing composition, forming a waterproof film, on the top side of a substrate, base or support; b) pass this substrate, base or support with the first layer of the water-base acrylic waterproofing composition forming a waterproof film, through a curing oven at a predetermined temperature and time; c) apply a second layer of a water-base acrylic waterproofing composition, forming a waterproof film, on this first layer, which can be with equal or different composition from the first and with equal or different thickness; d) pass this substrate, base or support with the first and second water-base acrylic waterproofing layer, forming a waterproof film, through a curing oven at a temperature and predetermined time; e) roll up the premanufactured waterproofing material.

Until this step, the premanufactured waterproofing material can be transferred to the application site, employing an adhesive that is applied on the surface to be waterproofed previously sealed with a liquid sealant and/or applied on the bottom side of the premanufactured waterproofing material to adhere it on the previously prepared surface to be waterproofed (free of dust, dirt and impurities, dry and if possible sealed with a liquid seal).

After going through step d), “n” layers of a composition equal to or different from the water-base acrylic waterproofing material can be applied with the corresponding curing steps.

Before step “e,” the premanufactured waterproofing material having “n” layers of the water-base acrylic waterproofing composition on the top side of the substrate, base or support, the process can comprise the following additional steps:

i) roll on the bottom side of the premanufactured waterproofing material a two-sided adhesive film (water-base or resin-base of the styrene acrylic resins or 100% acrylic resins or polyurethane resins type) that comprises a film backing, so as to later go on to step “e” (the film backing is removed to expose the adhesive and to adhere it to the surface to be waterproofed);

ii) apply on the bottom side of the premanufactured waterproofing material an adhesive (water-base or resin-base of the styrene acrylic resins or 100% acrylic resins or polyurethane resins type) by impregnation or aspersion and ii′) roll the film backing on this adhesive in order to later go on to step “e” (the film backing is removed to expose the adhesive and to adhere it to the surface to be waterproofed);

iii) apply on the bottom side of the pre-manufactured waterproofing material at least one layer of a water-base acrylic resin or at least one layer of a composition of a water-base acrylic waterproofing material equal to or different from the acrylic waterproofing composition of the at least two layers of the top side of the substrate, support or base or a sealant type waterproofing material, in order to later go on to step “e,” or to go on to step “i)” or to step “ii)”.

The invention has been sufficiently described so that a person with average knowledge in the matter can reproduce and obtain the results that we mention in the present invention. Nevertheless, any capable person in the field of technology of the present invention is capable of making modifications not described in this application. However, if applying these modifications in a particular structure or in the process of manufacturing the same involves a matter claimed in the following claims, these structures must be understood to be within the scope of the invention.

1. Acrylic premanufactured waterproofing material, water-base, wherein it comprises a substrate, base or support to give it a continuous structure, adapted to receive on its top side a first layer of a water-base acrylic waterproofing composition forming a waterproof film and at least one second layer forming a waterproof film on this first layer, of a water-base acrylic waterproofing composition equal to or different from the composition of the first layer.

2. Acrylic premanufactured waterproofing material, water-base, in accordance with claim 1, wherein this first layer and this at least one second layer of a water-base acrylic waterproofing composition have equal or different thickness.

3. Acrylic premanufactured waterproofing material, water-base, in accordance with claim 1, wherein this acrylic waterproofing composition can comprise a styrenated acrylic resin.

4. Acrylic premanufactured waterproofing material, water-base, in accordance with claim 1, wherein this substrate, base or support to give a continuous structure to the premanufactured waterproofing material is selected among a plastic film, rubber, a sheet of paper, cardboard, aluminum paper, fiber glass and preferably a fabric or nonfabric textile.

5. Acrylic premanufactured waterproofing material, water-base, in accordance with claim 4, wherein this fabric or nonfabric textile is made of synthetic or natural fibers, of a material selected among polyethylene, polypropylene, polyester, nylon, elastomeric polyurethane, glass fibers, natural or cellulous fibers.

6. Acrylic premanufactured waterproofing material, water-base, in accordance with claim 1, wherein this water-base acrylic waterproofing composition forming a film for the first and the at least second layer on the substrate, base or support comprises water, a water softener, a moisturizer, an antifreeze, a antifoaming agent, pigments, fine, medium and/or thickness loads, a binder or film former (resin), a germicide, a pH regulator, a coalescent, a thickener and a dispersant.

7. Acrylic premanufactured waterproofing material, water-base, in accordance with claim 6, wherein, in addition, it comprises mechanical reinforcement fibers selected from the group that comprises polyester fibers, polyethylene fibers, elastane fibers, rubber fiber (alloy type), neoprene fiber, natural rubber or synthetic rubber fiber or mixtures of the same.

8. Acrylic premanufactured waterproofing material, water-base, in accordance with claim 6, wherein this water softener and stabilizer comprises sodium or potassium tripolyphosphate, or sodium or potassium hexaphosphate.

9. Acrylic premanufactured waterproofing material, water-base, in accordance with claim 6, wherein this moisturizer comprises nonylphenol ethoxylate or another organic moisturizer.

10. Acrylic premanufactured waterproofing material, water-base, in accordance with claim 6, wherein this antifreeze comprises monoethylene glycol, diethylene glycol and/or propylene glycol.

11. Acrylic premanufactured waterproofing material, water-base, in accordance with claim 6, wherein this antifoaming agent is a mineral oil base antifoaming agent.

12. Acrylic premanufactured waterproofing material, water-base, in accordance with claim 6, wherein the pigments are selected among titanium dioxide, iron oxide (red, yellow, green and black), phthalos or phthalocyanine or other pigments.

13. Acrylic premanufactured waterproofing material, water-base, in accordance with claim 6, wherein these loads are selected from calcium carbonate, kaolin, talc, alumina, natural or artificial silicates, feldspar, mica, baryta and wollastonite, employing preferably a line and medium calcium carbonate mixture.

14. Acrylic premanufactured waterproofing material, water-base, in accordance with claim 6, wherein the pH regulator is ammonia and/or amine derivatives.

15. Acrylic premanufactured waterproofing material, water-base, in accordance with claim 6, wherein the germicide is formaldehyde or another organic biocide; the coalescent is pentanediol: the thickener is of acrylic, cellulose or polyurethane, and the dispersant is sodium or ammonium polyacrylate.

16. Acrylic premanufactured waterproofing material, water-base, in accordance with claim 1 wherein this water-base acrylic waterproofing composition that forms the first layer and the at least second layer on the substrate, base or support comprises 40-70% solids, a density of 1.10-1.45, a pH of 7.6-10.5 and a viscosity of 80,000-10,000 Cps.

17. Acrylic premanufactured waterproofing material, water-base, in accordance with claim 1, wherein, in addition, it comprises on the bottom side of the substrate, base or support, opposite the side where the at least two layers of an acrylic waterproofing composition are applied, a layer or film of an adhesive.

18. Acrylic premanufactured waterproofing material, water-base, in accordance with claim 17, wherein this adhesive is directly applied on the bottom side of the substrate, support or base by impregnation, aspersion, or laminated employing a film of double-sided adhesive material with a backing material that, when detached, leaves exposed the adhesive film to fix the premanufactured waterproofing material to the surface to be waterproofed.

19. Acrylic premanufactured waterproofing material, water-base, in accordance with claim 1, wherein this substrate, base or support of the premanufactured waterproofing material comprises on the bottom side at least one layer of water-base acrylic resin or at least one layer of a composition of a water-base acrylic waterproofing material equal to or different from the acrylic waterproofing composition of the at least two layers of the top side of the substrate, support or base or a sealant type waterproofing material.

20. Acrylic premanufactured waterproofing material, water-base, in accordance with claim 19, wherein, in addition, it comprises a layer or film of an adhesive applied by impregnation, aspersion, or laminated employing a film of double-sided adhesive material with a backing material that, when detached, leaves exposed the adhesive film to fix the premanufactured waterproofing material to the surface to be waterproofed.

21. A process for obtaining a water-base acrylic premanufactured waterproofing material, as claimed in claim 1, wherein it comprises the steps: a) apply a first layer of predetermined thickness of a water-base acrylic waterproofing composition, forming a waterproof film, on the top side of a substrate, base or support; b) cure this substrate, base or support with the first layer forming a waterproof film in a curing oven at a temperature and predetermined time; c) apply a second layer of a composition forming a waterproof film on this first layer, which can be with equal or different composition from the first and with equal or different thickness; d) cure this substrate, base or support with the first curing and second water-base acrylic waterproofing layer in a curing oven at a temperature and predetermined time; e) roll up the premanufactured waterproofing material.

22. The process as claimed in claim 21 wherein, after step “d,” “n” layers of a composition equal to or different from the water-base acrylic waterproofing material can be applied with the corresponding curing steps.

23. The process as claimed in claim 21, wherein, in addition, before step “e,” the premanufactured waterproofing material with “n” layers of the water-base acrylic waterproofing composition on the top side of the substrate, base or support comprises the step: i) roll on the bottom side of the premanufactured waterproofing material a two-sided adhesive film that comprises a film backing.

24. The process as claimed in claim 21, wherein, in addition, before step “e,” the premanufactured waterproofing material with “n” layers of the water-base acrylic waterproofing composition on the top side of the substrate, base or support comprises the step: ii) apply on the bottom side of the premanufactured waterproofing material an adhesive by impregnation or aspersion and ii′) roll the film backing on this adhesive.

25. The process as claimed in claim 21, wherein, in addition, before step “e,” the premanufactured waterproofing material with “n” layers of the water-base acrylic waterproofing composition on the top side of the substrate, base or support comprises the step: iii) apply on the bottom side of the premanufactured waterproofing material at least one layer off water-base acrylic resin or at least one layer of a composition of a water-base acrylic waterproofing material equal to or different from the acrylic waterproofing composition of the at least two layers of the top side of the substrate, support or base or a sealant type waterproofing material, in order to later go on to step “e,” or to go on to step “i)” step or to step “ii)” of claims 23 and 24.
